(19) United States
(12) Patent Application Publication
(10) Pub. No.: US 2010/0117931 A1
(43) Pub. Date: May 13, 2010

(54) FUNCTIONAL IMAGE REPRESENTATION

(75) Inventors: J. Turner Whitted, Carnation, WA (US); James Thomas Kajiya, Duvall, WA (US); Erik S. Ruf, Kirkland, WA (US); Ray A. Bittner, JR., Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/267,628

(22) Filed: Nov. 10, 2008

(51) Int. Cl. G09G 3/20

(52) U.S. Cl. 345/55

(57) ABSTRACT

A display apparatus described herein includes a display screen and a display processor. The display processor includes a plurality of function units that comprise functions that are representative of data that is desirably displayed on the display screen. The display processor is configured to receive configurations, compositions, and/or parameters for the plurality of function units. In addition, the display processor displays data on the display screen based at least in part upon output of the plurality of function units.

### BACKGROUND

Graphical displays that display data, images, etc. through use of digital technology have become increasingly prevalent in recent years. Furthermore, displays have become increasingly larger and can display images with much higher resolution when compared with display screens of the recent past. For instance, a television with a liquid crystal display (LCD) display can have a diagonal distance of seventy inches or more. Furthermore, consumers are comfortable with larger and larger displays, such that over time a wall in a house may desirably be a display.

While consumers anticipate ever-growing displays, current display architecture may limit a) potential size of a display screen and/or b) potential resolution of a display. More particularly, as displays become larger and more dense (e.g., as displays have higher resolution), bandwidth and processing power corresponding to displays must increase. The conventional display architecture includes a central processing unit (CPU) that is positioned in close proximity to a graphics processor. The CPU instructs the graphics processor to process passive data structures to create pixels, and transmit pixels through cabling to a display. Such an architecture does not scale, as the amount of data that can be transmitted by way of the cabling is finite.

### SUMMARY

The following is a brief summary of subject matter that is described in greater detail herein. This summary is not intended to be limiting as to the scope of the claims.

Described herein are various technologies pertaining to image processing and display on a display screen. More particularly, an architecture is described herein, wherein images can be represented in such architecture through use of functions, and wherein the functions can be evaluated in close proximity to a display screen.

Pursuant to an example, the architecture can include a front end graphics processor or front end general purpose processor. A function configuration and parameter buffer can be communicatively coupled to the graphics processor. A global memory channel and/or a global configuration channel can be employed in connection with communicatively coupling the graphics processor and the function configuration and parameter buffer, wherein a channel can be a bus, a wireless communication channel, or any other suitable communication channel. Moreover, for purposes of explanation, the global memory channel and the global configuration channel are described herein as being different communication channels—it is to be understood, however, that functionality corresponding to these two channels can be combined. The architecture can also include a plurality of configurable function units. A function unit can include fixed functions or can be configured to include any suitable function. The function units can be communicatively coupled to the graphics processor by way of the global memory channel. A global configuration channel can be employed to communicatively couple the function units and the function configuration and parameter buffer.

In operation, the front-end graphics processor can receive data that is desirably displayed on a display screen. The graphics processor can, for instance, partition the data in accordance with desired display locations to facilitate parallel processing. The front-end graphics processor can also receive pixel data (e.g., data that is already formatted for display at one or more pixels on the display screen).

The front-end processor can generate configurations, compositions, and parameters for functions in the plurality of function units. Such configurations, compositions, and parameters can be provided to the function configuration and parameter buffer, and can downloaded to the function units by way of the global configuration channel. The function units can also be provided with screen coordinates, and functions therein (e.g., fixed and/or downloaded from the global configuration channel) can be evaluated based at least in part upon the screen coordinates. An image can be displayed on the display screen based at least in part upon the screen coordinates.

Other aspects will be appreciated upon reading and understanding the attached figures and description.

### BRIEF DESCRIPTION OF THE DRAWINGS

FIG. 1 is a functional block diagram of an example system that facilitates displaying an image on a display screen.

FIG. 2 illustrates an example display system architecture.

FIG. 3 illustrates an example configuration of function units.

FIG. 4 illustrates an example image that can be displayed on a display screen based upon the configuration of function units of FIG. 3

FIG. 5 illustrates an example function unit.

FIG. 6 is an example system that facilitates downloading parameters for function units in connection with displaying data on a display screen.

FIG. 7 illustrates an example modular display.

FIG. 8 is a flow diagram that illustrates an example methodology for displaying an image on a display screen.

FIG. 9 is a flow diagram that illustrates an example methodology for outputting a red, green, and blue value to a display screen.

FIG. 10 is a flow diagram that illustrates an example methodology for configuring a display processor.

FIG. 11 is a flow diagram that illustrates an example methodology for displaying an image on a display screen.

FIG. 12 is an example computing system.

### DETAILED DESCRIPTION

Various technologies pertaining to displays in general, and representing images through use of functions in a display in particular, will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

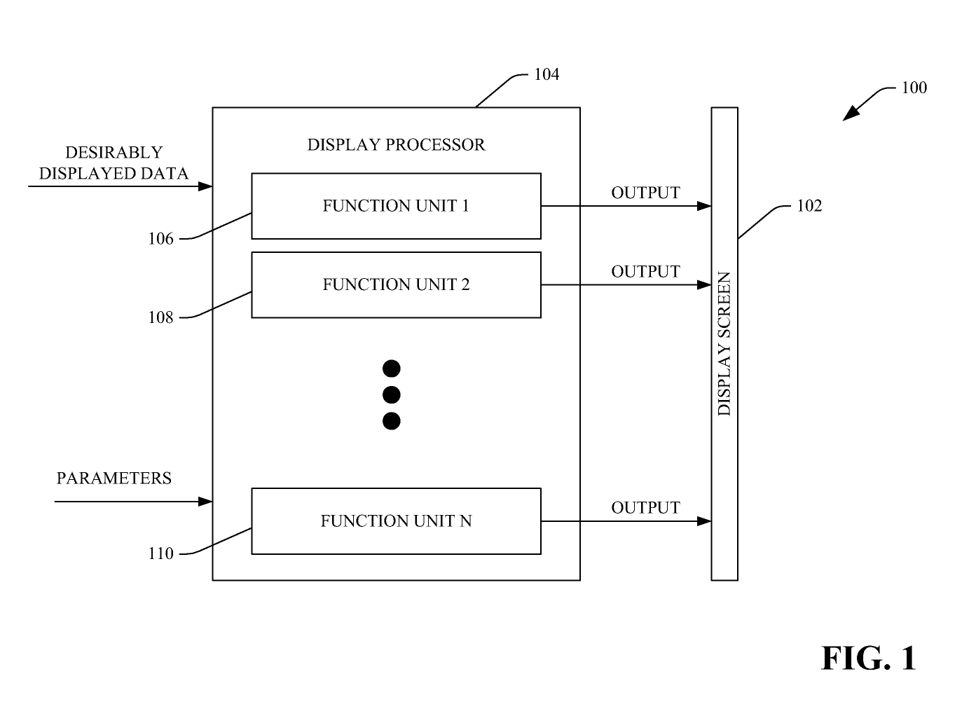

With reference to FIG. 1, an example system 100 that facilitates displaying an image on a display is illustrated. The system 100 may be a portion of a television system, a computing system, or other suitable system that uses a display. The system 100 includes a display screen 102 that can be configured to display images, including video images, static images, etc. Pursuant to an example, the display 102 may be a liquid crystal display, a plasma display, an organic light-emitting diode (LED) display, or other suitable display.

The system 100 additionally includes a display processor 104 that can include a plurality of function units 106-110. A function unit can include a function that can be employed to represent at least a portion of an image, wherein the function unit can be configured, composed, and/or parameterized to represent at least the portion of the image. In an example embodiment, a function can be a mathematical function that causes data input to the function, such as screen coordinate data, to be modified through use of at least one mathematical operator to create an output value. In another example, a function can be a logical operator such as an AND operator, an OR operator, etc. In yet another example, a function can be a combination of one or more mathematical functions and one or more logical functions. Further, a function unit can be hardware and/or software that includes a function that can be used in connection with representing at least a portion of an image. Thus, a function unit can be electronic circuitry that is configured execute a particular function, memory that includes instructions for executing a particular function, a microprocessor programmed to execute a function, etc.

Furthermore, as used herein, configuring a function unit can refer to selecting a particular type of function to be included in the function unit, composition of a function unit can refer to defining how function units interact with one another, and parameterization can refer to providing particular values for a functions parameters. With respect to composing function units, the system 100, for example, can include a first function unit and a second function unit, and the function units can be composed such that the output of the first function unit is received as input of the second function unit. Function units can be composed dynamically as data that is desirably displayed on the display screen is received and represented by functions. Moreover, as alluded to above, a function unit can include a function that can be configured, composed, and/or parameterized based at least in part upon received data that is desirably displayed on the display screen 102, such as video data. The function in the function unit can be any suitable function, including but not limited to linear expression evaluators, quadratic expression evaluators, or pixel composition functions. Function units will be described in greater detail below.

The display processor 104 can be configured to receive data that is desirably displayed on the display screen 102. For instance, the data may be a portion of video data, and can be in any suitable format and can be associated with any suitable codec, including MPEG-1, MPEG-2, MPEG-4, MJPEG, DV, WMV, amongst others. Furthermore, the video data may have any suitable wrapper, such as AVI, WMV, or ASF, amongst others. In another example, the data may be a portion of static image data and can be in any suitable format, such as JPEG, TIFF, etc.

The display processor 104 can also be configured to receive configurations, compositions, and/or parameters that correspond to the received data. For instance, configurations, compositions, and/or parameters can be provided to the display processor 104, which in turn can be provided to at least a subset of the function units 106-110 to configure, compose, and/or parameterize such function units. Pursuant to an example, the parameters can be based at least in part upon a format of the received data that is desirably displayed on the display screen.

A subset of the configured, composed, and/or parameterized function units 106-110 can process coordinates of the display screen 102 where data is desirably displayed (e.g., X, Y coordinates), and functions in the subset of the function units 106-110 can be evaluated based at least in part upon the processed coordinates, causing the subset of the function units 106-110 to generate an output. For instance, an output generated by a function unit may be red, green, and blue values for display on a particular portion of the display screen 102. Red, green, and blue values can be used to define a pixel—it is to be understood, however, that other colors can be used in connection with defining an output of a pixel, and that red, green, and blue values are discussed herein for purposes of explanation. Thus, the display processor 104 is configured to display data on the display screen based at least in part upon the output of the subset of parameterized function units 106-110.

Pursuant to an example, the function units 106-110 can be physically distributed across the display screen 102, such that the function units 106-110 can act in parallel when displaying data on the display screen 102. For example, the first function unit 106 can be configured to cause data to be displayed on a first portion of the display screen 102, the second function unit 104 can be configured to cause data to be displayed on a second portion of the display screen, etc. The function units 106-110 can be configured, parameterized, and/or composed such that the first function unit 106 includes a function that is representative of data that is to be displayed on the first portion of the display screen 102, the second function unit 108 includes a function that is representative of data that is to be displayed on the second portion of the display screen 102, etc. Input to a function unit can be X, Y screen coordinates pertaining to the portion of the display screen 102 that corresponds to the function unit, and output of the function unit can be a red, green, blue value (or other suitable value) for a pixel that corresponds to a certain X, Y coordinate. Accordingly, instead of passive data structures representing images that are desirably displayed on a display screen 102, dynamically configurable functions (which can be parameterized and composed as described above) can be employed in connection with representing images that are desirably displayed on the display screen 102.

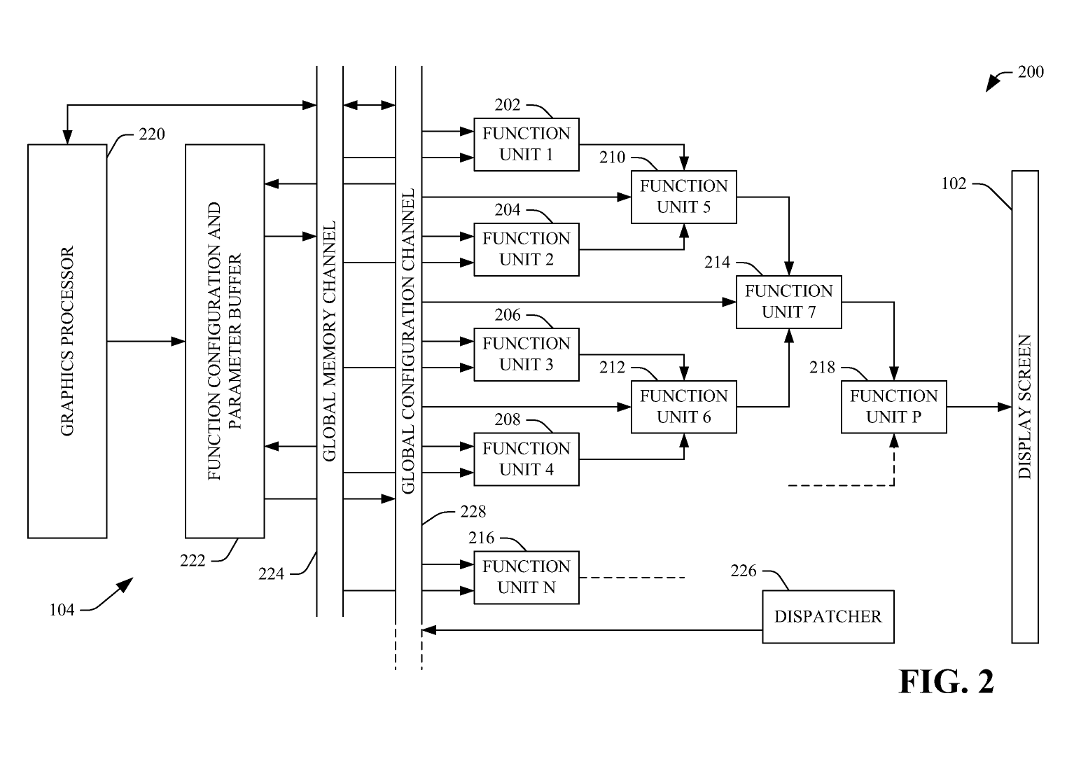

Now referring to FIG. 2, an example system 200 that facilitates representing images through use of functions is illustrated. The system 200 includes the display screen 102 and the display processor 104, which can act as described above. As noted above, the display processor 104 includes a plurality of function units 202-218, wherein the function units 202-218 can include functions that can be configured, composed, and/or parameterized to represent desirably displayed images.

The display processor 104 can also include a front-end graphics processor 220. The front-end graphics processor 220 can be configured to parse through text and/or imagery desirably displayed on the display screen 102, and can be employed in connection with determining function configurations, compositions, and/or parameters that can be representative of the text and/or imagery (e.g., data) desirably displayed on the display screen 102. For instance, the graphics processor 220 can sort data based at least in part upon a location on the display screen 102 where the data is desirably displayed (e.g., to facilitate parallel processing), and can determine function configurations, compositions, and/or parameters based at least in part upon a location on the display screen 102 where the data is desirably displayed.

The display processor 104 may additionally include a function configuration and parameter buffer 222, which can be employed in connection with retaining configurations, compositions, and/or parameters for a subset of the function units 202-218. A global memory channel 224 can act as a general purpose memory bus, for instance. In an example, the global memory channel 224 can provide the function units 202-218 with conventional pixel data—thus, the display processor 104 can act as a hybrid device, such that pre-configured pixels can be displayed on the display screen 102 together with data that is represented through use of function units. In another example, the global memory channel 224 can be employed in connection with transitioning function configurations, compositions, and/or parameters from the front end graphics processor 220 to the function configuration and parameter buffer 222. Other data may also be transmitted by way of the global memory channel 224.

The display processor 104 can also include a dispatcher 226 that can determine a location (e.g., X, Y pixel coordinates or a block of coordinates) on the display screen 102 where data is desirably displayed. In addition, the dispatcher 226 can optionally determine a value for time that indicates when the data is desirably displayed on the display screen 102. Based at least in part upon the determined location (and, optionally, time), the dispatcher component 226 can retrieve information (e.g., configurations, compositions, and/or parameters) pertaining to the subset of the function units 202-218 that can be used to display data on the display screen 102. A global configuration channel 228 can be employed in connection with providing the information to the dispatcher 226, and such information can be retrieved, for instance, from the function configuration and parameter buffer 222. The information can include information such as how the subset of the function units 202-218 are to be configured, composed, type of function(s) (e.g., linear function, circular arc, bi-linear ramp, . . . ) that are to be implemented in the function units, parameters pertaining to the functions, how function units are to be cascaded (e.g., how output of a first function unit is to be composed with outputs of other function units, how function units can be combined to generate a more complex function, . . . ). As noted above, it is to be understood that the global memory channel 224 and the global configuration channel 228 are presented to illustrate transfer of data between elements of the architecture, and that any suitable communications technology can be used to perform such transfer of data.

The dispatcher 226 can cause certain configurations/compositions/parameters to be downloaded from the function configuration and parameter buffer 222 to the subset of the function units 202-218 based at least in part upon the information retrieved by the dispatcher 226 and/or the data that is desirably displayed on the display screen 102. Thus, the subset of the function units 202-218 can be configured based at least in part upon a location determined by the dispatcher 226, data that is desirably displayed on the display screen 102 at the determined location, type of function corresponding to the subset of the function units 202-218, and how the subset of the function units 202-218 are desirably cascaded/combined.

The subset of the function units 202-218 can evaluate X and Y values (e.g., provided by the dispatcher 226) using their respective functions, and images can be displayed on the display screen 102 based at least in part upon output of the subset of the function units 202-218. As noted above, an output of a function unit can be a red, green, blue value for a particular pixel (in accordance with the X, Y value). In an example, the X and Y values can be evaluated in raster order. As noted above, other colors can be used to define a pixel, and the claims are not intended to be limited to red, green, and blue values.

It can be understood that in accordance with the description above, the function units 202-218 can be configured to evaluate X and Y values at a substantially similar point in time. To facilitate rapid switching between configuration and evaluation, the function units 202-218 can include one or more registers that facilitate switching between configurations when evaluating functions.

It can also be discerned that the system 200 is not shown as including a clock. It is understood, however, that a clock may be employed to synchronize function units 202-218. In another example, the function units 202-218 can be combinational in nature. In yet another example, the function units 202-218 can be or include arrays of sequential processors, wherein the processors can communicate via shared memory in addition or alternatively to communicating via channels such as buses.

In an example operation of the display processor 104, the front-end graphics processor 220 can receive image data by way of the global memory channel 224, for example. The graphics processor 220 can parse the received image data and sort the data based at least in part upon a location on the display screen 102 where the data is desirably displayed. Based at least in part upon the format of the received image data, various function configurations, compositions, and/or parameters can be downloaded into the function configuration and parameter buffer 222.

The dispatcher 226 can receive information pertaining to which function units are to receive particular configurations, compositions, and/or parameters to represent the received image data. The dispatcher 226 can control downloading of function configurations, compositions, and/or parameters into the function units 202-218 such that the function units can be representative of the image data, wherein the configurations, compositions and/or parameters can be transmitted by way of the global configuration channel 228. In this example, each of the function units 202-218 can be provided with configurations by way of the global configuration channel 228 (e.g., from the function configuration and parameter buffer 222). The configured, composed, and/or parameterized function units 202-218 can be evaluated with respect to X, Y coordinates. In an example, the function unit P 218 output can be a red, green, blue value for a particular pixel or set of pixels on the display screen 102.

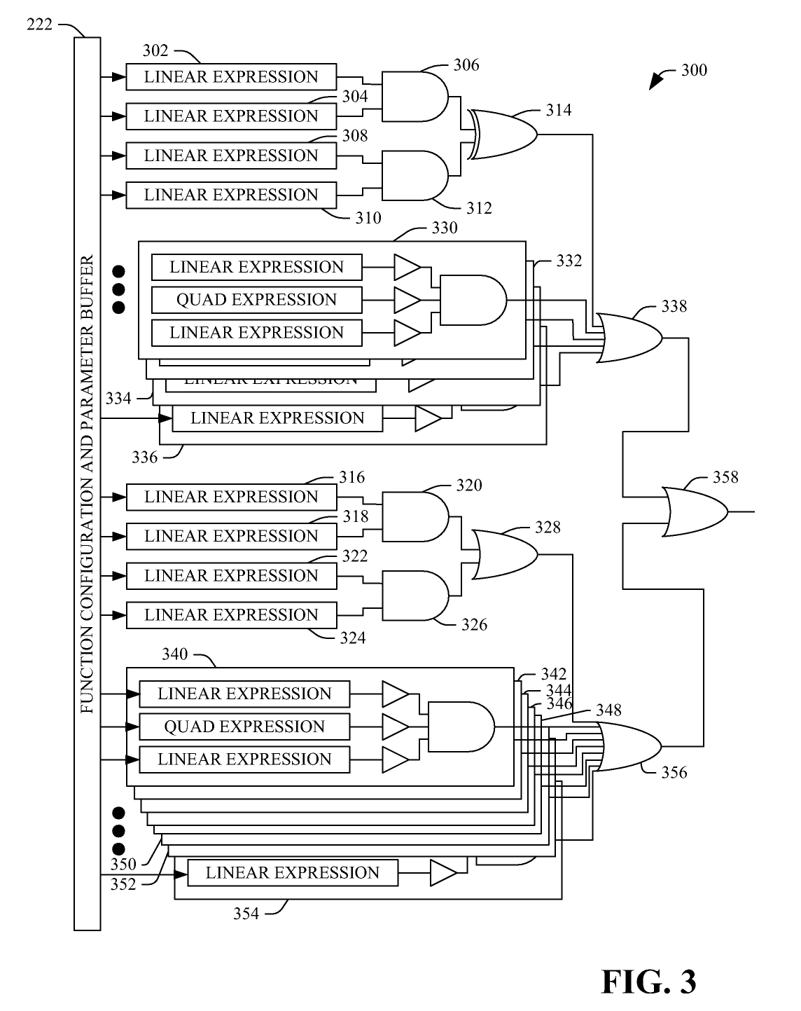

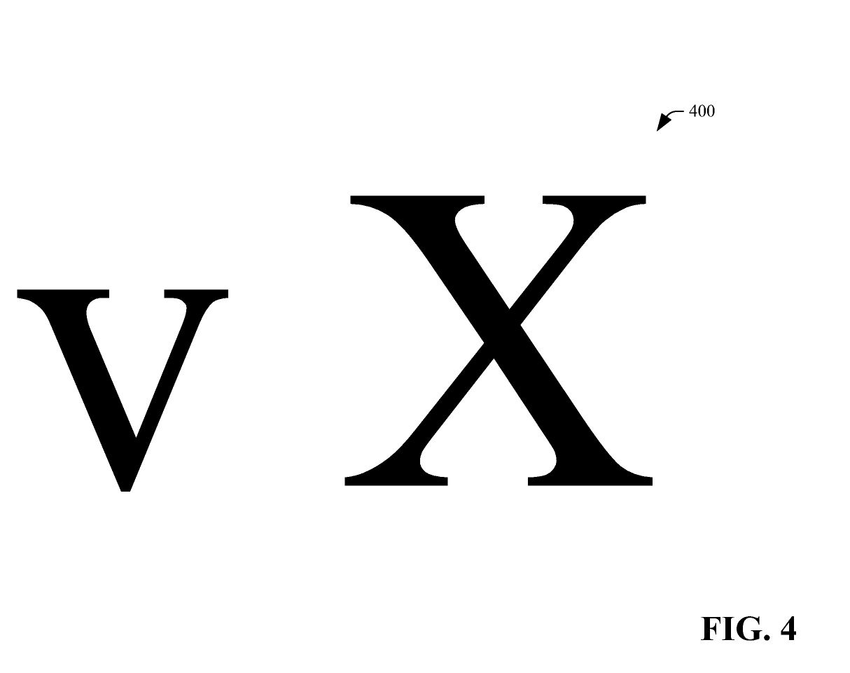

Now referring to FIG. 3, an example configuration 300 of function units is illustrated. The configuration 300 can be used in connection with representing an example logo 400 depicted in FIG. 4. Functions/logic used in connection with determining and forwarding minimum distances used for anti-aliasing as well as anti-aliasing function(s) are omitted for sake of clarity. With more particularity, the example logo 400 in FIG. 4 includes the letter “V” and the letter “X”. The configuration is an approximation of a common font with circular arcs replacing second order Bezier curves.

The configuration 300 includes a configuration for the “V” glyph, which includes two wedges that define the body of the “V”. The output of two function units 302 and 304 (shown as linear expressions) are provided to a function unit 306 (which can be or include a first AND gate), and the output of two different function units 308 and 310 (also shown as linear expressions) are provided to another function unit 312 (which can be or include a second AND gate). The output of the function unit 306 defines the first wedge, and the output of the function unit 312 defines the second wedge. A function unit 314 (e.g., which can be or include an XOR gate) receives the output of function units 306 and 312. The function units 302-314 can define the body of the “V” in the logo 400 (FIG. 4).

The body of the “X” in the logo 400 can be defined in a similar manner. For instance, the configuration 300 includes a configuration for the “X” glyph, which includes two cross sections that define the body of the “X”. As shown, the output of two function units 316 and 318 (shown as being or including linear expressions) are provided to a function unit 320 (which can be or include an AND gate), and the output of two different function units 322 and 324 are provided to another function unit 326 (which can also be or include an AND gate). The output of the function unit 320 defines the first cross section, while the output of the function unit 326 defines the second cross section. A function unit 328, which can be or include an OR gate, receives the output of the function units 320 and 326. The function units 316-328 can be employed to define the body of the “X” in the logo 400.

As can be discerned from the logo 400, the letter “V” includes two serifs while the letter “X” includes four serifs. Each of the serifs can be represented by two function units, wherein each of the function units includes two linear expressions and a quadratic expression, and the output of each of the functions can be buffered and provided to an AND gate, respectively.

With respect to the letter “V”, four function units 330-338 can be used to define the two serifs. In an example, each of the function units 330-338 can include two linear expressions and a quadratic expression, where each of the expressions are buffered and provided to an AND gate in the respective function units. The output of the four function units 330-336 can be provided to a function unit 338 (which can be or include an OR gate), which can also receive the output of the function unit 314. The output of the function unit 338 can indicate whether a pixel is to be activated for the letter “V” (depending on X, Y coordinates on a display screen).

With respect to the letter “X”, eight function units 340-354 can be used to define the four serifs. In an example, each of the function units 340-354 can include two linear expressions and a quadratic expression, where each of the expressions are buffered and provided to an AND gate in the respective function units. The output of the eight function units 340-354 can be provided to a function unit 356 (which can be or include an OR gate), which can also receive the output of the function unit 328. The output of the function unit 356 can indicate whether a pixel is to be activated for the letter “X” (depending on X, Y coordinates on a display screen).

The configuration can additionally include a function unit 358 (e.g., which can be or include an OR gate), which can receive the outputs of the function units 328 and 356, respectively. The output of the function unit 358 can be provided to a display screen. As different X and Y values are provided to the function units in the configuration 300, the output can change. In another example, a range of X and Y values can be provided to the function units in the configuration 300, and the respective function units can cycle through the range of X and Y values.

For purposes of explanation and simplicity, the configuration 300 does not illustrate comparators used to delimit vertical or horizontal edges that do not require full linear expression evaluators—comparators can be included for bounds checking and such bounds may be incorporated into an outline of the text.

Furthermore, at least some of the function units in the configuration 300 are shown as being fixed in nature (e.g., function units 306, 312, 314, 320, 326, 328, 338, 356, and 358), while others (such as function units including expression values) can be parameterized. For instance, the function unit 302 can be parameterized based at least in part upon data that is desirably displayed on a display screen. It is to be understood, however, that the function units may include RAM, DRAM, DDRAM, etc. such that functions in the function units can be configured, composed, and/or parameterized as data that is desirably processed changes. Moreover, a function unit may include multiple functions or a single function. For instance, if a function unit is a processing device, the processing device can be programmed to execute a plurality of functions. In another example, a function unit can be circuitry, such as a FPGA, and a function unit can include a single function.

Still further, it can be discerned that in certain circumstances some functions may not output useful results. For instance, the configuration 300 can be thought of as a program executed within a function array. As with programs executed in a sequential processor, not all branches produce a useful result. For instance, one or the other glyph can be visible at a given pixel, but not both. For this case, a simple composition of linear functions can produce a clipping boundary for the function array (all of the function units in the configuration 300) that indicates which portion of the tree to evaluate. In the example configuration, parameters defining the configuration of both glyphs can be stored in registers within the function tree, and a simple switch can activate a first or second set of parameter registers. Caching of parameters can reduce a number of arithmetic expressions from 44 for the entire tree to 30 as the worst case re-used tree, including two expressions added as a clipping boundary.

Accordingly, the function array can be pruned such that only functions overlapping a single pixel remain—however, this may place a burden on a front-end graphics processor. Thus, double buffering can be employed for an entire function configuration.

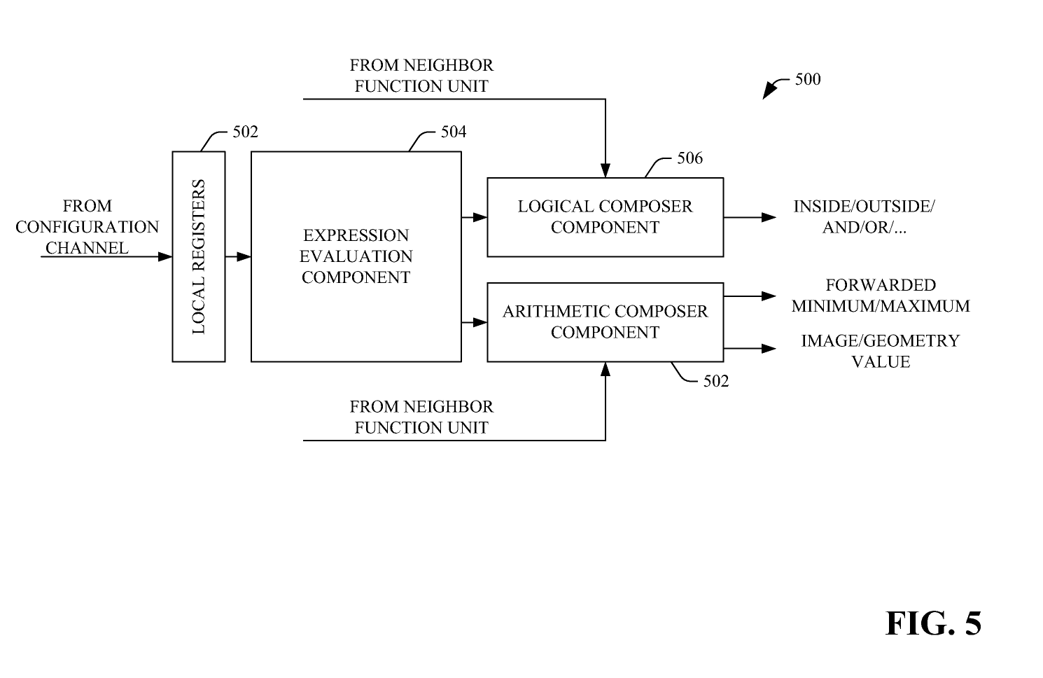

Now turning to FIG. 5, an example function unit 500 is illustrated. It is to be understood that the architecture of the example function unit 500 is merely provided for purposes of explanation, and that various implementations of function units are possible. The example function unit 500 is but one implementation amongst numerous possible implementations.

The function unit 500 includes local registers 502 that can be configured to receive and (temporarily) store configurations, compositions, and/or parameters that can be received from the function configuration and parameter buffer 222 (FIG. 2) by way of the global configuration channel 228. Furthermore, the local registers 502 can receive X, Y values that are to be evaluated by the function unit 500.

An expression evaluation component 504 can include a function and/or be configured to include a function (e.g., from the local registers 502). The expression evaluation component 504 can evaluate the function with parameters and X,Y values provided from the local registers 502.

The function unit 500 can also include a logical composer component 506, which can logically compose output of the expression evaluation component 504 with an output from a neighboring function unit (not shown). For instance, the logical composer component 506 can be or include any suitable gate, such as an AND gate, an OR gate, an XOR gate, can be an inside or outside composition, etc.

The function unit 500 may also include an arithmetic composer component 508 that can arithmetically compose output of the expression evaluation component 504 with output of a neighboring function unit (not shown). The logical composer component 506 and the arithmetic composer component 508 can receive outputs from the same neighboring function unit or different function units. The output of the arithmetic composer component 508 can include minimum and/or maximum values, a range of values, an image/geometry value, etc. Such values can be used in connection with displaying data in the display screen 102 (FIG. 1).

The function unit 500 may be implemented in any suitable circuitry. In an example, the function unit 500 (and other function units in an array) can be embedded in a display screen. In another example, the function unit 500 may be included in a field programmable gate array (FPGA), in an application-specific integrated circuit (ASIC), or other suitable circuit technology. In another example, the function unit 500 can be designed as a portion of a plastic substrate, can include non-silicon elements, can include organic transistors, amorphous silicon, etc.

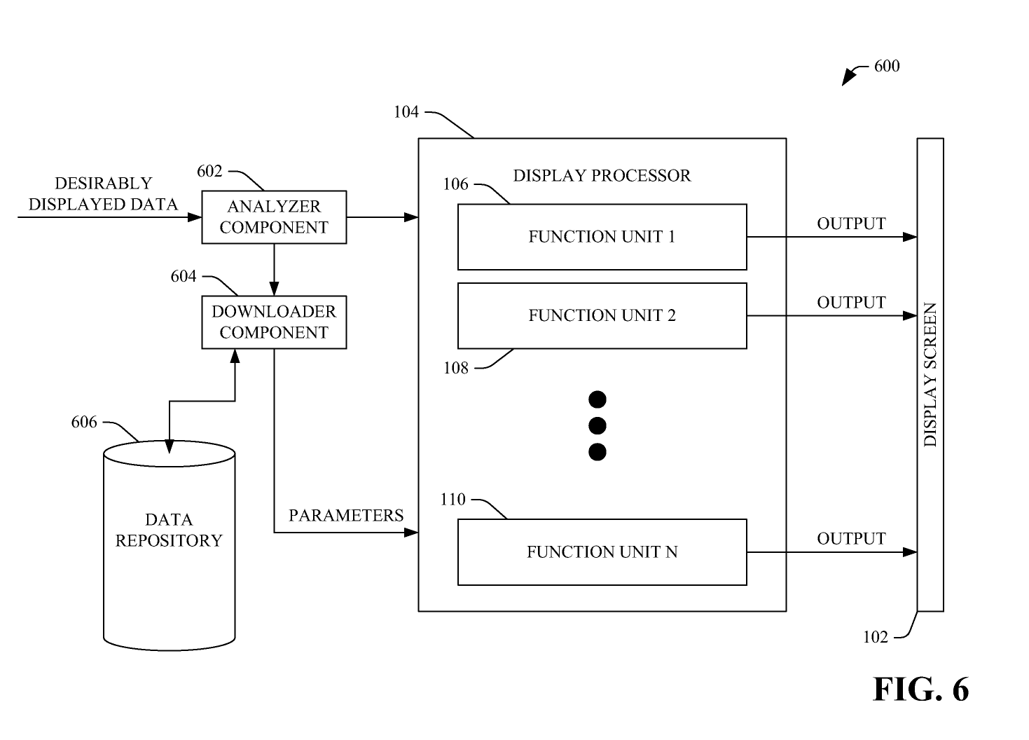

Now referring to FIG. 6, an example system 600 that facilitates downloading configurations, compositions, and/or parameters that can be employed by an array of function units is illustrated. The system 600 includes the display screen 102 and the display processor 104, which can act as described above. The display processor 104 includes the function units 106-110, which can be at least a portion of an array of function units. As described above, the function units 106-110 can be configured, composed, and/or parameterized such that they can be used to represent images that are desirably displayed on the display screen 102.

The system 600 can additionally include an analyzer component 602 that can receive data that is desirably displayed on a display screen. For instance, the data can be an image in a particular format, such as a JPEG image. In another example, the data can be video in a certain format. In still another example, the received data may be in a type of compressed format.

The analyzer component 602 can analyze the received data and determine a format of such data. A downloader component 604 can be in communication with the analyzer component 602, and can be instructed to download information pertaining to the format of the desirably displayed data as determined by the analyzer component 602. The information may include parameters for functions in the function units, information regarding how function units are to interact (how function units are to be composed), logical and/or arithmetic combination of output of function units (how function units are to be configured), etc. A data store 606 can include downloadable information, and the downloader component 604 can selectively download the information from the data store 606.

In an example, the data store 606 may be accessible over a network connection. For instance, the data store 606 may be a portion of an online server. In another example, the data store 606 may be accessible by way of a memory bus. Thus, the data store 606 may reside in a substantially similar computing device as the display processor 104.

The information downloaded by the downloader component 604 can be provided to the display processor 104, and a subset of the function units 106-110 can be composed, configured and/or parameterized based at least in part upon the downloaded information.

Pursuant to an example, the system 600 can act as a flexible compression/decompression system. The desirably displayed data may be a compressed JPEG, which can be represented by a plurality of coefficients. The plurality of coefficients can be a representation of the image. Such coefficients can be provided as the desirably displayed data to the display processor 104 generally, and to a subset of the function units 106-110 in particular. The analyzer component 602 can determine that the desirably displayed data is a compressed JPEG, and the downloader component 604 can download information pertaining to decompressing JPEG images from the data store 606 based at least in part upon the determination made by the analyzer component 602. Such information can be used to configure, compose, and/or parameterize the function units 106-110, and the compressed JPEG can be converted to pixels through utilization of the function units 106-110.

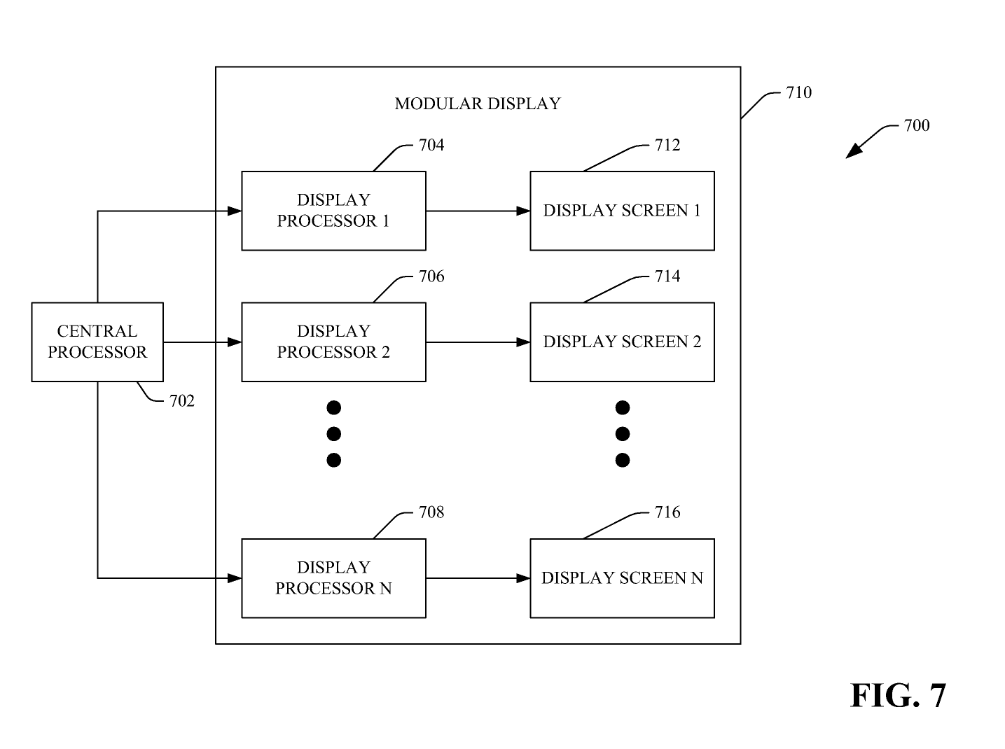

Turning now to FIG. 7, an example system 700 that facilitates displaying data on modular displays is illustrated. The system 700 includes a central processor 702. A plurality of display processors 704-708 can be in communication with the central processor 702, and can be included as a portion of a modular display 710 that can display images. In an example, the modular display 710 can include the plurality of display processors 704-708 and a plurality of display screens 712-716, wherein different display screens can display different portions of an image.

In operating, the central processor 702 can receive data that is desirably displayed through use of the modular display 710, wherein the desirably displayed data includes an image that is to be displayed over the plurality of display screens 712-716. The central processor 702 can be configured to partition the desirably displayed data into different portions, and a particular portion of the desirably displayed data can be directed to a certain one of the display processors 704-708 depending upon where the portion is desirably displayed in the modular display 710. Data provided to the display processors 704-708 can be in a native form—in other words, the central processor 702 need not transmit pixels to the display processors 704-708.

The display processors 704-708 can operate as described above. In summary, the display processors can each include a plurality of function units, and the plurality of function units can be composed, configured, and/or parameterized “on the fly” based upon the data that is desirably displayed. The display processors 704-708 can be proximate to the display screens 712-716, respectively. Accordingly, pixel data need not be pushed from the central processor 702 to all of the display screens 712-716 in the modular display 710.

While the system 700 is shown as including a central processor 702, it is to be understood that any one of the display processors 704-708 can act as a master processor that can perform tasks described above as being performed by the central processor 702. Selection of a master processor from amongst the display processors 704 can facilitate design and creation of autonomous units without requiring appendage of a master controller.

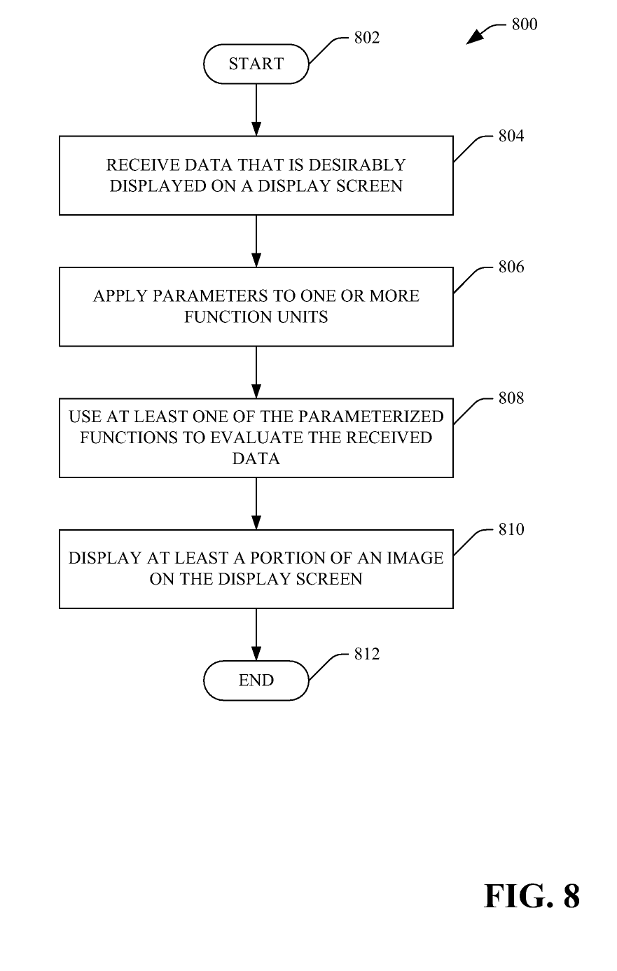

With reference now to FIGS. 8-11, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Turning specifically to FIG. 8, an example methodology 800 for using functions to represent an image for display is illustrated. The methodology 800 starts at 802, and at 804 data that is desirably displayed on a screen is received. The screen, for instance, may be an LCD screen, a plasma screen, or the like. In another example, the screen may be a projector screen.

At 806, parameters are applied to one or more functions to create parameterized functions based at least in part upon a format of the received data. For instance, the parameterized functions can represent an image that corresponds to the received data. In an example, the functions can be incorporated in a function unit, which can be or include configurable circuitry and a memory buffer. In another example, the function unit can include a microprocessor and an associated memory, wherein the memory can include instructions that emulate a function and the processor can execute the instructions.

At 808, at least one of the parameterized functions can be used to evaluate the received data, wherein the at least one of the parameterized function generates an output. For instance, the output can be a red, green, blue value. In another example, the output can be provided as input to another function (e.g., consumed by another function unit).

At 810, at least a portion of the image can be displayed on the display screen based at least in part upon the output of the at least one of the parameterized function units. The methodology 800 completes at 812.

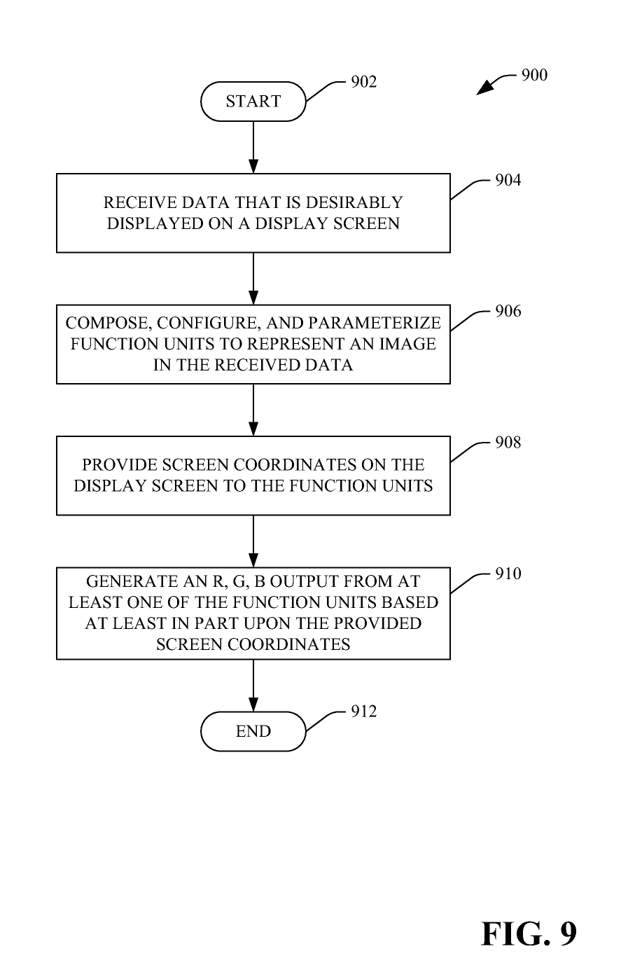

With reference now to FIG. 9, an example methodology 900 for displaying data on a display screen is illustrated. The methodology 900 starts at 902, and at 904 data that is desirably displayed on a display screen is received. The data can include a video image, a static image, etc.

At 906, function units are configured, parameterized, and composed to represent an image in the received data. As noted above, the image can be a video image or a static image.

At 908, screen coordinates from the display screen are provided to the function units. For instance, the display screen can be partitioned into a plurality of areas, and screen coordinates pertaining to a particular area can be provided to a function unit. Partitioning of the display allows for parallel processing to be undertaken through use of the function units.

At 910, a red, green, and blue output is generated from at least one of the function units, wherein the red, green and blue output is based at least in part upon the screen coordinates provided to the function units. The methodology 900 completes at 912.

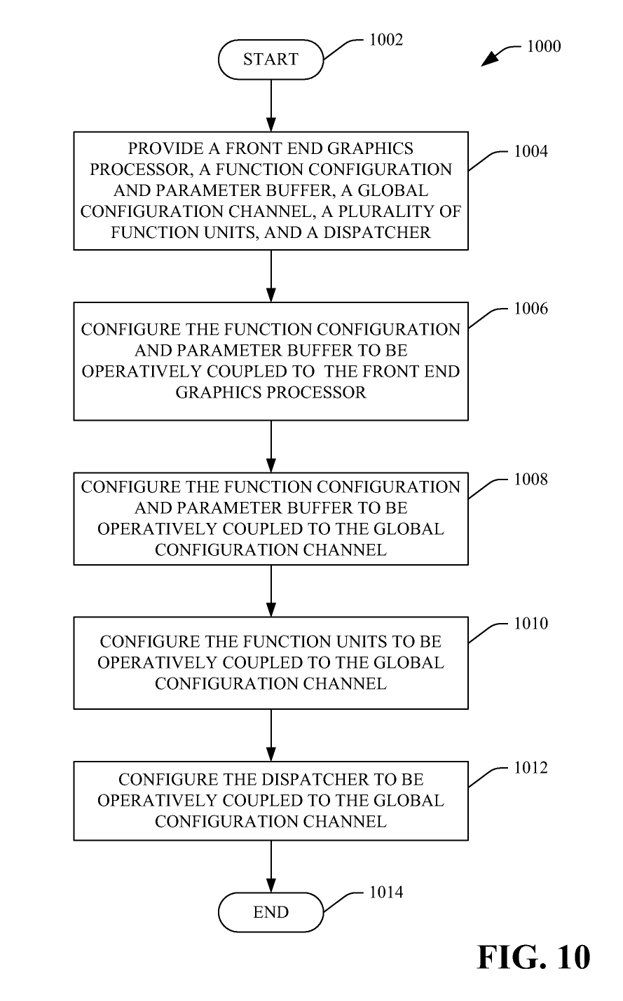

Now referring to FIG. 10, an example methodology 1000 for configuring a display processor is illustrated. The methodology 1000 starts at 1002, and at 1004 a front end graphics processor, a function configuration and parameter buffer, a global configuration channel, a plurality of function units, and a dispatcher are provided.

At 1006, the function configuration and parameter buffer is configured to be operatively coupled to the front end graphics processor. Accordingly, desirably displayed data can be partitioned by the front-end graphics processor and, for instance, provided to the function configuration and parameter buffer. In another example, the front end graphics processor can receive the desirably displayed data and can generate configurations and compositions for functions, and such configurations and compositions can be provided to the function configuration and parameter buffer. In yet another example, the front end graphics processor can provide configurations and compositions to the function units by way of a general purpose memory channel.

At 1008, the function configuration and parameter buffer is configured to be operatively coupled to the global configuration channel. In addition, the function configuration and parameter buffer can be operatively coupled to the general purpose memory channel.

At 1010, the function units are configured to be operatively coupled to the global configuration channel. Accordingly, compositions, configurations, and/or parameters for functions can be provided to the function units from the function configuration and parameter buffer.

At 1012, the dispatcher is configured to be coupled to the global configuration channel. The dispatcher can act as a controller for configuring, composing, and parameterizing functions in the function units, and can communicate with the function units and the function configuration and parameter buffer by way of the global configuration channel. The methodology 1000 completes at 1014.

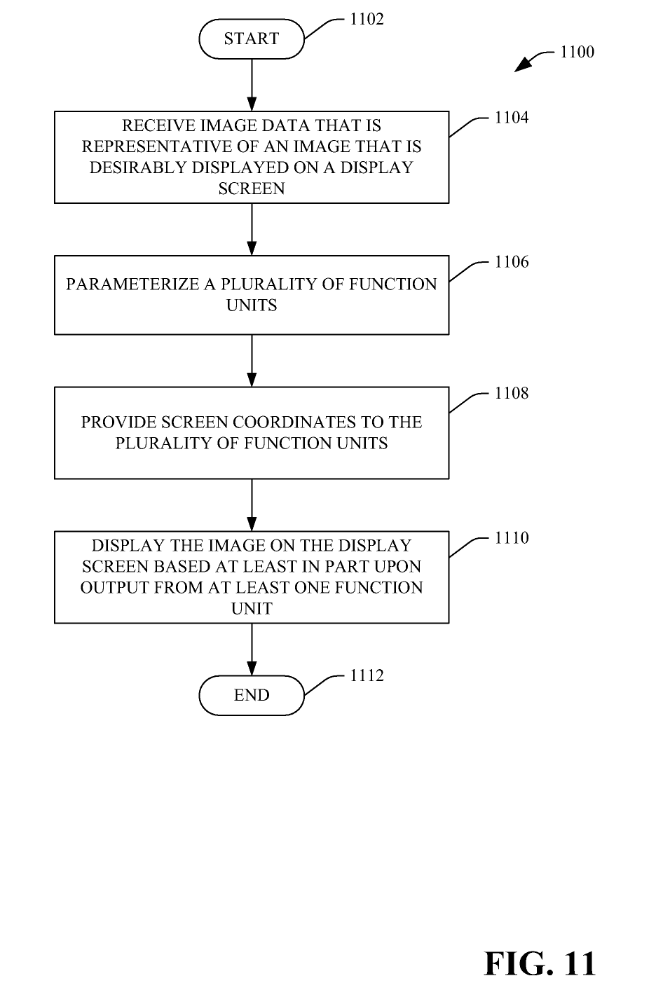

Turning now to FIG. 11, an example methodology 1100 for displaying an image on a display screen is illustrated. The methodology 1100 starts at 1102, and at 1104 image data that is representative of an image that is desirably displayed on a display screen is received. The image data can be in any suitable format.

At 1106, a plurality of function units are parameterized, wherein each of the plurality of function units can include at least one function, and wherein the plurality of function units can include functions that are representative of the image. In an example, at least one of the plurality of function units can be embedded in the display screen.

At 1108, screen coordinates are provided to the plurality of function units, wherein at least one of the plurality of function units can be configured to generate an output based at least in part upon the screen coordinates. In an example, the screen coordinates can be a range of screen coordinates.

At 1110, the image is displayed on the display screen based at least in part upon the generated output. The methodology 1100 completes at 1112.

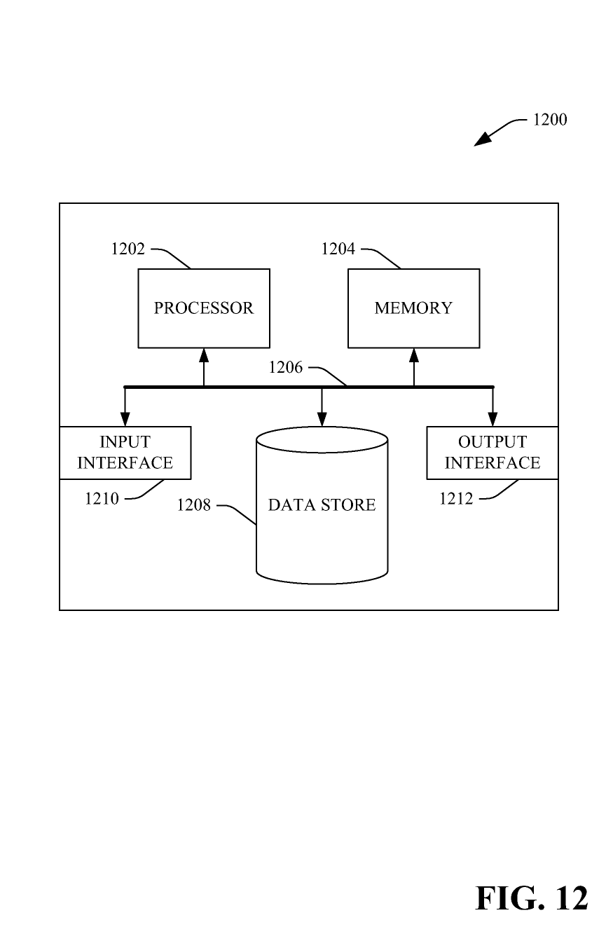

Now referring to FIG. 12, a high-level illustration of an example computing device 1200 that can be used in accordance with the systems and methodologies disclosed herein is illustrated. For instance, the computing device 1200 may be used in a system that can be used to display images on a display system. The computing device 1200 includes at least one processor 1202 that executes instructions that are stored in a memory 1204. The instructions may be, for instance, instructions for implementing functionality described as being carried out by one or more components discussed above or instructions for implementing one or more of the methods described above. The processor 1202 may access the memory 1204 by way of a system bus 1206. In addition to storing executable instructions, the memory 1204 may also store data pertaining to image display, including pixel data, compression algorithms, etc.

The computing device 1200 additionally includes a data store 1208 that is accessible by the processor 1202 by way of the system bus 1206. The data store 1208 may include executable instructions, image data, configuration, composition, and parameter data for function units, etc. The computing device 1200 also includes an input interface 1210 that allows external devices to communicate with the computing device 1200. For instance, the input interface 1210 may be used to receive instructions from an external computer device, receive image data from an external device, receive instructions from a user, etc. The computing device 1200 also includes an output interface 1212 that interfaces the computing device 1200 with one or more external devices. For example, the computing device 1200 may transmit data to a display device by way of the output interface 1212.

Additionally, while illustrated as a single system, it is to be understood that the computing device 1200 may be a distributed system. Thus, for instance, several devices may be in communication by way of a network connection and may collectively perform tasks described as being performed by the computing device 1200.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A display apparatus comprising:
a display screen; and
a display processor, wherein the display processor comprises a plurality of function units that include functions that are representative of data that is desirably displayed on the display screen, wherein the display processor is configured to receive configurations, compositions, and/or parameters for the plurality of function units, and wherein the display processor displays data on the display screen based at least in part upon output of the plurality of function units.

2. The display apparatus of claim 1, wherein the display processor further comprises a configuration buffer that dynamically updates the configurations, compositions, and/or parameters for the plurality of function units.

3. The display apparatus of claim 2, wherein the configuration buffer updates the configurations, compositions, and/or parameters for the plurality of function units based at least in part upon a format of the desirably displayed data.

4. The display apparatus of claim 1, wherein at least one of the plurality of function units is embedded in the display screen.

5. The display apparatus of claim 1, wherein a television comprises the display screen.

6. The display apparatus of claim 1, further comprising a global configuration channel that broadcasts the configurations, compositions, and/or parameters and screen space coordinates to each of the plurality of function units.

7. The display apparatus of claim 1, wherein a subset of the function units comprise one or more of the following types of functions: linear expression evaluators, quadratic expression evaluators, and/or pixel composition functions.

8. The display apparatus of claim 1, wherein an output of a first function unit in the plurality of function units is received as an input to a second function unit in the plurality of function units.

9. The display apparatus of claim 1, wherein at least one of the plurality of function unit outputs a red, green, and blue value for a pixel that is displayed on the display screen.

10. The display apparatus of claim 1, further comprising:
an analyzer component that determines a format of the data that is desirably displayed on the display screen; and
a downloader component that automatically downloads configurations, compositions, and/or parameters pertaining to the format determined by the analyzer component, wherein the plurality of function units are configured, composed, and/or parameterized in accordance with the downloaded configurations.

11. The display apparatus of claim 1, wherein at least one of the plurality of function units is included in a field programmable gate array or an ASIC.

12. The display apparatus of claim 1, wherein at least one of the plurality of function units is included in non-silicon logic.

13. The display apparatus of claim 1, wherein the display screen is one of a liquid crystal display or an organic light-emitting diode display.

14. A method comprising the following computer-executable acts:
receiving data that is desirably displayed on a display screen;
applying parameters to one or more functions to create parameterized functions based at least in part upon a format of the received data, wherein the parameterized functions represent an image that corresponds to the received data;
using at least one of the parameterized functions to evaluate the received data, wherein the at least one of the parameterized functions generates an output; and
displaying at least a portion of the image on the display screen based at least in part upon the output.

15. The method of claim 14, further comprising:
determining a format of the received data; and
selecting parameters to apply to the functions based at least in part upon the determined format of the received data.

16. The method of claim 15, wherein the determined format is a compression format.

17. The method of claim 14, wherein the output of the function is based at least in part upon screen coordinates input to the at least one function.

18. The method of claim 17, wherein the screen coordinates are evaluated in raster order.

19. The method of claim 14, further comprising passing the output of the at least one of the parameterized functions to another function.

20. A computer-readable medium comprising instructions that, when executed by a processor, cause the processor to perform the following acts:
receive image data that is representative of an image that is desirably displayed on a display screen;
parameterize a plurality of function units, wherein each of the plurality of function units include at least one function, and wherein the plurality of function units include functions that are representative of the image, wherein at least one of the plurality of function units is embedded in the display screen;
provide screen coordinates to the plurality of function units, wherein at least one of the plurality of function units is configured to generate an output based at least in part upon the screen coordinates; and
display the image on the display screen based at least in part upon the generated output.
